(19) United States
(12) Patent Application Publication
(10) Pub. No.: US 2005/0169294 A1
(43) Pub. Date: Aug. 4, 2005

(54) Dynamic network load balancing method and system

(75) Inventors: Yu-Chee Tseng, Hsinchu (TW); Tseng-Huei Juan, Hsinchu (TW)

Correspondence Address: EDWARDS & ANGELL, LLP, P.O. BOX 55874, BOSTON, MA, 02205, US

(73) Assignee: RDC Semiconductor Co., Ltd., Hsinchu (TW)

(21) Appl. No.: 11/044,136

(22) Filed: Jan. 26, 2005

(30) Foreign Application Priority Data
Jan. 20, 2004 (TW) 093101513

(51) Int. Cl. H04J 3/16

(52) U.S. Cl. 370/437

(57) ABSTRACT

Dynamic network load balancing method and system are applicable to a wireless communication network. A channel-detecting module detects channels that provide wireless communications between network stations and a plurality of access points. A signal-sending module sends a probing data packet to each of the access points in a predetermined period via the channels detected by the channel-detecting module. A signal-receiving module receives a response data packet from each of the access points after receiving the probing data packets. A load-judging module calculates a response time between sending the probing data packet by the signal-sending module and receiving the response data packet by the signal-receiving module. A channel-selecting module selects a channel with the shortest response time for data transmission based on the response time for each of the channels calculated by the load-judging module. The channel-selecting module also can switch channels according to a predetermined threshold value for switching.

### FIELD OF THE INVENTION

The present invention relates to a dynamic network load balancing method and system, and more particularly, to a dynamic network load balancing method and system which is applicable to a wireless communication network.

### BACKGROUND OF THE INVENTION

Owing to the progress of technology for network communication system, demands of the network communication system, from organizations such as governments, large-scaled corporations or schools that require fast data transmission as well as medium-small corporations or personal offices, increase significantly. The maturity of the Internet environment has brought about high-speed information generation and exchange. Thus, an efficient network communication environment is probably a most basic requirement for keeping up the pace with the evolution of the Information age.

Apart from a wired network communication system which is based on physical wires such as cables or telephone wires, a demand for portable communication is also gradually increased due to the miniaturization of information equipments. In a portable communication environment, not only the equipment has to be portable per se, a wireless communication architecture is also essential. For example, a wireless local area network (WLAN), which is a data transmission system, provides an extension for a wired local area network or another option for transmission channel. Through the use of radio frequency techniques or wireless networks, wireless transmission effectively minimizes the requirement of an actual wired connection. Therefore, the wireless network combines data networking as well as a user's mobility. Thus, the user is able to perform network connection and data transmission anywhere in home or office via the wireless local area network without being affected by any actual wires.

Although a wireless network communication system is characterized by convenience in utilization, the wireless network and the wired network are both inherent with a problem of controlling load balances between channels. For example, consider wireless local area network architecture used in an ordinary family, the family is assumed to have five stations, such as a notebook computer, and two access points (APs). Each of the stations is provided with a wireless network card compliant with IEE802.11b specification and the access point is a wireless data transmission router also compliant with the IEEE802.11b specification, If four of the stations perform wireless network connection via the channel of one of the access points, and if the fifth station still performs the wireless network connection via the same channel, then data transmission of the five stations would be performed in a single channel. Thus, no station performs data transmission via the channel of the other access point. Obviously, loadings on these two channels are not balanced, which consequently reduces utilization efficiency.

In the case of wireless local area architecture with only a few numbers of stations, the channels can be selected by the user based on present using conditions of the channel. However, it is very difficult for the users to monitor the using condition if there are excess numbers of stations or access points or difficulties in establishing contact between the users. In order to solve such problem, prior-art techniques have disclosed many methods such as connecting via a channel with less stations, received selecting a preferred channel based on Received Signal Strength Indication (RSSI) and Packet Error Rate (PER) of a channel between a detecting station and a plurality of access points. Alternatively, a method of clear channel assessment (CCA) can be employed to determine an average signaling time in air of each channel to therefore, identify the busiest access point.

However, the foregoing prior arts still have significant drawbacks. The number of linked stations does not necessarily reflect the actual loading conditions. The idle rate of a channel linked with more stations may be high, such that connecting via such channel would be more efficient than that via a channel linked with fewer stations but with a higher utilization rate. Similarly, selecting a channel based on strong signal strength and low packet error rate may result in selecting a channel with strong signal strength and low packet error rate but heavy load and low data transmission efficiency. Additionally, in the method of using the average signaling time in air of each of the channels for channel selection, a more preferable channel cannot be further determined if both have the same loadings. In fact, in exemplification of IEEE 802.11b, the users in the same channel have to acquire utilization of frequency bandwidth via a “competition” method. For a new station, a channel having the same loading with another channel but linked to fewer stations would be more preferable as it is less competitive. Additionally, the foregoing prior arts merely provide channel selection methods before entering the channel, so the alteration of loadings for each of the channels caused by variations in the numbers of stations or using conditions cannot be considered after connecting. In other words, the load of the channel cannot be dynamically balanced.

Accordingly, what is needed, therefore, is to provide a dynamic network load balancing method and system.

### SUMMARY OF THE INVENTION

In light of the above conventional drawbacks, a primary objective of the present invention is to provide a dynamic network load balancing method and system, by which a channel having higher transmission efficiency is selected for connection according to detection of actual data transmission efficiency of each channel.

Another objective of the present invention is to provide a dynamic network load balancing method and system, by which a channel having higher transmission efficiency is dynamically selected for connection according to regular detection of actual data transmission efficiency of each channel.

In accordance with the above and other objectives, the present invention proposes a system which comprises a channel detecting module for detecting a channel for providing wireless communication between a network station and a plurality of access points; a signal-sending module for sending probing data packets to the access points via the channels detected by the channel-detecting module according to a predetermined period; a signal-receiving module for receiving response data packets from the access points that received the probing data packets; a load-judging module for calculating response times between sending the probing data packet by the signal-sending module and receiving the response data packet by the signal-receiving module; and a channel-selecting module for selecting the channel with the shortest response time for data transmission from the response time of each of the channels calculated by the load-judging module. Additionally, the channel-selecting module further performs channel switching based on a predetermined threshold value for channel switching.

A dynamic network load balancing method based on the foregoing system is also proposed in the present invention. First of all, a channel-detecting module detects a channel for providing wireless communication between a network station and a plurality of access points (APs). Then, a signal-sending module sends probing data packets to the access points via the channel detected by the channel-detecting module according to a predetermined period. A signal-receiving module receives response data packets from the access points that received the probing data packets. A load-judging module calculates response times between sending the probing data packets by the signal-sending module and receiving the response data packets by the signal-receiving module. Finally, a channel-selecting module selects the channel with the shortest response time for data transmission according to the response time of each of the channels calculated by the load-judging module. Additionally, the channel-selecting module further performs channel switching according to a predetermined threshold value for channel switching.

In comparison to wireless network channel selection techniques known in the prior art, the dynamic network load balancing method and system proposed in the present invention is capable of dynamically selecting a channel having higher data transmission efficiency by regular detection of the actual data transmission efficiency of each channel. Therefore, the station is capable of dynamically selecting the channel with the most efficient transmission from a plurality of channels to perform data transmission.

### BRIEF DESCRIPTION OF THE DRAWINGS

The present invention can be more fully understood by reading the following detailed description of the preferred embodiments, with reference made to the accompanying drawings, wherein

FIG. 1 is a schematic diagram showing application architecture of a dynamic network load balancing method and system according to the present invention;

FIG. 2 is a schematic diagram showing architecture of a dynamic network load balancing system according to the present invention; and

FIG. 3 is a flowchart showing operating steps of a dynamic network load balancing method according to the present invention.

### DETAILED DESCRIPTION OF THE EMBODIMENTS

The present invention is described in the following with specific embodiments, so that one skilled in the art can easily understand other advantages and effects of the present invention from the disclosure of the invention. The present invention may also be implemented and applied according to other embodiments, and the details may be modified based on different views and applications without departing from the spirit of the invention.

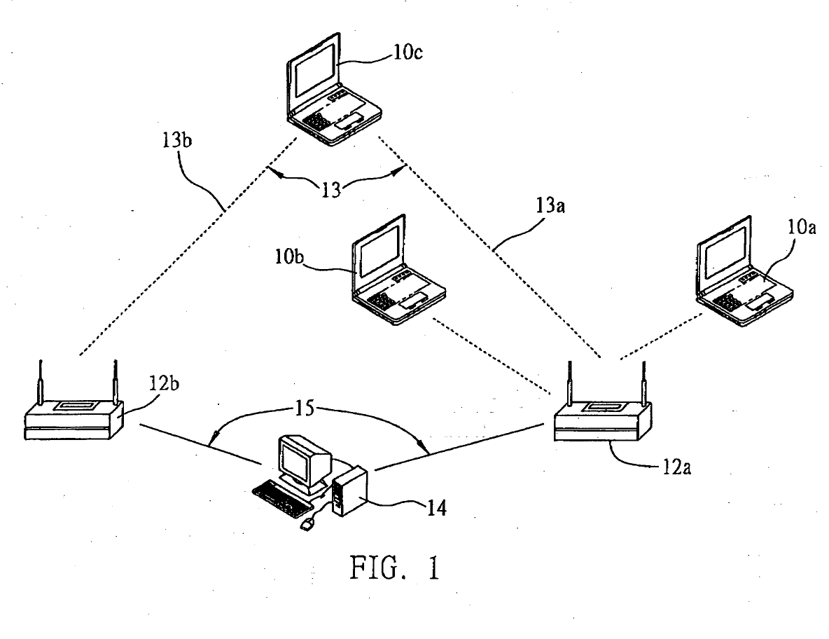

FIG. 1 is a schematic diagram showing application architecture of a dynamic network load balancing method and system according to the present invention. In the present embodiment, the application architecture comprises stations 10a, 10b and 10c, access points 12a and 12b and a remote file transfer protocol (FIT) server 14. The stations 10a, 10b and 10c are notebook computers having wireless network cards of IEEE 802.11b specification. The access points 12a and 12b are wireless data transmission routers with IEEE 802.11b specification. Further, a wireless local area network 13 comprising channels 13a and 13b is formed between the stations 10a, 10b and 10c and the access points 12a and 12b. The access points 12a and 12b and the file transfer protocol server 14 are linked by a conventional asymmetric digital subscriber line (ADSL) Internet architecture 15. Specifically, the application architecture is only an exemplification, in which communication specification is not limited by IEEE 802.11b and other similar wireless transmission protocols can also be used. Additionally, the stations can be replaced by other data processing devices having a wireless communication function, such as personal computers and personal digital assistances, etc. The numbers of the station, access point and remote server can be reduced or increased according to the wireless communication protocol.

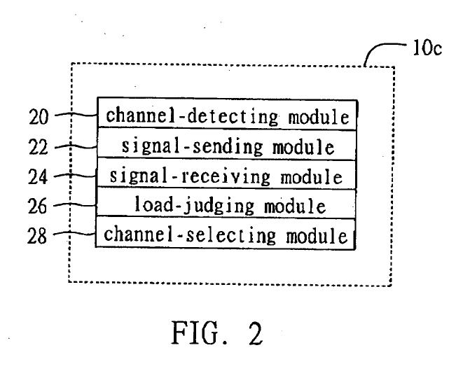

FIG. 2 is a schematic diagram showing architecture of a dynamic network load balancing system 2 according to the present invention. The system 2 comprises a channel-detecting module 20, a signal-sending module 22, a signal-receiving module 24, a load-judging module 26 and a channel-selecting module 28. What needs to be specifically illustrated is that, in the present embodiment, the dynamic network load balancing system 2 proposed in the present invention is individually constructed in the stations 10a, 10b and 10c. In order to emphasize the technical feature of the present invention, Only relevant elements and steps are illustrated. Actually, one skilled in the pertinent art should understand that application of the elements require other software/hardware units or modules. Additionally, the foregoing modules are software program modules which can be executed via the stations 10a, 10b and 10c. However, the modules can be operated in terms of firmware or hardware.

The channel-detecting module 20 serves to detect the channels 13a and 13b for providing wireless communication between the stations 10a, 10b and 10c and the access points 12a and 12b. As previously mentioned, in the present embodiment, the stations 10a and 10b establish connection with the file transfer protocol server 14 via the channel 13a linked between the stations 10a and 10b and the access point 12a and via the Internet architecture 15. If station 10c wishes to select a channel with lower loading between the station 10c and the access points 12a and 12b for wireless connection, then the channel-detecting module 20 sends a wireless detecting signal to determine any present access point and its corresponding channel which can be linked. In the present embodiment, the channel-detecting module 20 should detect channels 13a and 13b, which provide wireless communication between the station 10c and the access points 12a and 12b.

The signal-sending module 22 serves to send a probing data packet to access points 12a and 12b via channels 13a and 13b detected by the channel-detecting module 20 in a predetermined period. As previously mentioned, in the present embodiment, after channels 13a and 13b that provide wireless communication between the station 10c and the access points 12a and 12b have been detected by the channel-detecting module 20, the signal-sending module 22 sends the probing data packet to access points 12a and 12b via channels 13a and 13b, respectively, in the predetermined period. Said period can be one sending per minute after the first sending in the present embodiment, such that the loading condition of each channel can be dynamically monitored. What needs to be specifically illustrated is that the time period is determined according to practical requirements A software program or a hardware module (not shown) may be used for timing, in order to periodically actuate the signal-sending module 22 for sending the probing data packets.

The signal-receiving module 24 serves to receive a response data packet from the access points 12a and 12b that receive the probing data packet sent by the signal-sending module 22. As previously mentioned, in the present embodiment, after the probing data packet is respectively received by the access points 12a and 12b via the channels 13a and 13b, the response data packet is immediately sent to the signal-receiving module 24 via the channels 13a and 13b.

The load judging module 26 serves to calculate a response time between sending the probing data packet by the signal-sending module 22 and receiving the response data packet by the signal receiving module 24. As previously mentioned, in the present embodiment, the calculated response time between sending the probing data packet via the channel 13a and receiving the response data packet by the signal-receiving module 24 is 0.35 microseconds; and the calculated response time between sending the probing data packet via the channel 13b and receiving the response data packet by the signal-receiving module 24 is 0.25 microseconds. The load-judging module 26 determines that channel 13b has smaller loading and subsequently sends a signal indicating channel 13b has smaller loading to the channel-selecting module 28.

It should be specifically illustrated that the signal-sending module 22 sends the probing data packet to each access points 12a and 12b via the channels 13a and 13b every minute. The response data packet is also sent back to the signal-receiving module 24 from the access points 12a and 12b via the channels 13a and 13b, respectively. Thus, the load-judging module 26 is capable of dynamically determining the loading condition of each of the channels.

The channel-selecting module 28 serves to select the channel with shortest response time for data transmission according to the response time of the channels 13a and 13b calculated by the load-judging module 26. As previously mentioned, in the present embodiment, after the channel-selecting module 28 receives the signal sent by the load-judging module 26 indicating that the channel 13b has smaller loadings, the: station 10c is then linked to the access point 12b via the channel 13b, so as to link the station 10c to the file transfer protocol server 14 via the Internet architecture 15′. What needs to be specifically illustrated is that the channel-selecting module 28 dynamically selects a channel based on results of the load-judging module 26 which periodically determines the load condition of each of the channels.

Apart from dynamic channel selection based on the load-judging module 26, the channel-selecting module 28 further offers a function of providing threshold values for channel switching set by a user. For example, a 0.3 microsecond threshold value may be preset by the user, if the response time between sending the probing data packet via the channel 13a and receiving the response data packet by the signal-receiving module 24 is 0.28 microseconds; and the response time between sending the probing data packet via the channel 13b and receiving the response data packet by the signal-receiving module 24 is 0.25 microseconds, the channel-selecting module 28 does not perform any channel switching as the preset threshold value of channel switching has not been reached. This avoids a condition that time spent data for switching channels is longer than the time saved after switching channels, thus reducing overall data transmission efficiency.

Similarly, the channel-selecting module 28 further offers a function of providing a basis for channel switching according to a predetermined size of data transmission. For example, a predetermined 2 Mb data transmission size is set as the basis for channel switching, then the channel-selecting module 28 needs to determine whether data transmitted by the user has a size larger than 2 Mb in addition to dynamically selecting the channel according to the determination result of the load-judging module 26. If the size turns out to be smaller than 2 Mb, the channel does not need to be switched, avoiding the condition that time spent for channel switching is longer than the time spent for transmitting the data in the original channel. Conversely, if the size turns out to be larger than 2 Mb, channel switching is advantageous, so the channels will be switched by the channel-selecting module 28.

It is specifically illustrated that the load-judging module 26 determines the channel dynamically, so if the size of data transmission is used as a basis for determining whether the channel should be switched, then such determination is also dynamic. In the case of a 10 Mb size of data transmission at initial of data downloading, the size of data meets the requirement of channel switching of the channel-selecting module 28. When after some time, 9 Mb of data has been downloaded and 1 Mb of data is remained, the channel selecting module 28 does not switch channel according to the dynamic determining result obtained by the load-judging module 26.

Furthermore, the multiple functions of the foregoing channel-selecting module 28 can be partially or completely and synchronously or successively operated, such that the channel selection and the data transmission efficiency can be more accurately improved.

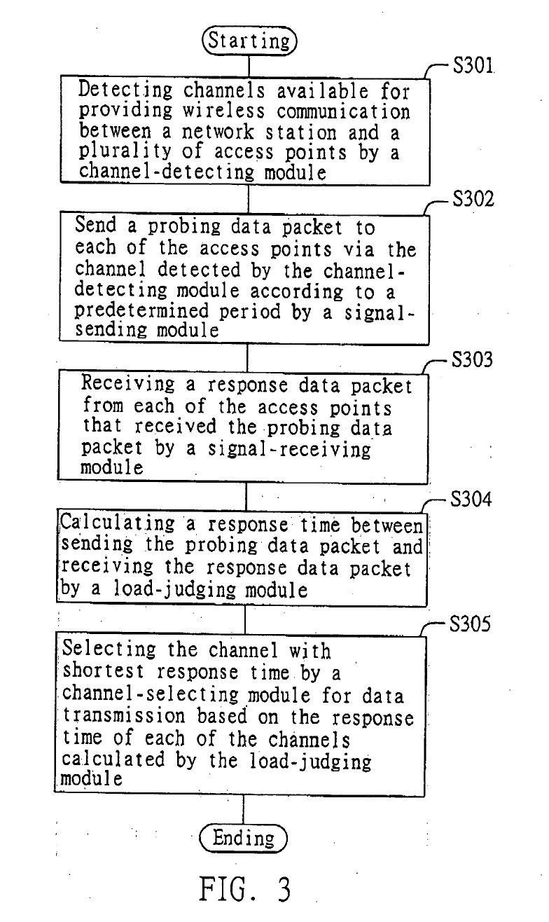

FIG. 3 is a flowchart showing operational steps of a dynamic network load balancing method according to the present invention.

Referring to step S301, the channel-detecting module 20 serves to detect the channels 13a and 13b for providing wireless communication between the stations 10a, 10b and 10c and the access points 12a and 12b. As previously mentioned, the channel-detecting module 20 determines the present access points and channels which can be linked by sending out a wireless detecting signal. In the present embodiment, the cannel-detecting module 20 is capable of detecting the channels 13a and 13b available for providing wireless communication between the stations and the access points 12a and 12b.

Referring to step S302, the signal-sending module 22 serves to send the probing data packet to the access points 12a and 12b via the channels 13a and 13b detected by the channel-detecting module 20 in the predetermined period. As previously mentioned, in the present embodiment, after the channels 13a and 13b that provides wireless communication between the stations and the access points 12a and 12b have been detected by the channel-detecting module 20, the signal-sending module 22 then sends the probing data packet to the access points 12a and 12b via the channels 13a and 13b, respectively.

Referring to step S303, the signal-receiving module 24 serves to receive the response data packet from the access points 12a and 12b that receive the probing data packet sent by the signal-sending module 22. As previously mentioned, in the present embodiment, after the probing data packet is respectively received by the access points 12a and 12b via the channels 13a and 13b, the response data packet is then sent back to the signal-receiving module 24 via the channels 13a and 13b.

Referring to step S304, the load-judging module 26 serves to calculate response time between sending the probing data packet by the signal-sending module 22 and receiving the response data packet by the signal-receiving module 24. As previously mentioned, in the present embodiment, the load-judging module 26 determines that channel 13b is the channel having smaller loadings and subsequently sends a signal to the channel-selecting module 28 indicating that the channel 13b has smaller loadings.

Referring to step S305, the channel-selecting module 28 serves to select the channel with the shortest response time for data transmission according to the response times of the channels 13a and 13b calculated by the load-judging module 26. As previously mentioned, in the present embodiment, after the channel-selecting module 28 receives the signal sent by the load-judging module 26 indicating that the channel 13b has smaller loadings, the station 10c is then linked to the access point 12b via the channel 13b, so as to link the station 10c to the file transfer protocol server 14 via the Internet architecture 15. If the user prefers to finish connecting, procedures will be ended. Conversely, if the user prefers to continue operating wireless local area networking, the procedure would be returned to the step S302. What needs to be specifically illustrated is that for the probing data packet to be periodically sent, timing is processed by using a software program or a hardware module, such that the signal-sending module 22 is regularly actuated to send out the probing data packets.

As previously mentioned, the channel-selecting module 28 also has functions of providing threshold values of channel switch set by the user and a reference for channel switching according to a predetermined size of data transmission. Thus, apart from dynamically selecting the channel with the shortest response time for data transmission based on the response time of the channels 13a and 13b calculated using the load-judging module 26, the channel-selecting module 28 is capable of synchronously or successively and partially or completely switching the channel using the foregoing additional function as the reference.

The invention has been described using exemplary preferred embodiments. However, it is to be understood that the scope of the invention is not limited to the disclosed embodiments. On the contrary, it is intended to cover various modifications and similar arrangements. It is intended that the following claims be interpreted to embrace all such variations and modifications.

1. A dynamic network load balancing method applicable to a wireless communication network, comprising the steps of:
having a channel-detecting module detect channels available for providing wireless communications between stations and a plurality of access points;
having a signal-sending module send a probing data packet to each of the access points in a predetermined period via the channels detected by the channel-detecting module;
having a signal-receiving module receive a response data packet sent from each of the access points after the access points have received the probing data packets;
having a load-judging module calculate a response time between sending the probing data packet by the signal-sending module and receiving the response data packet by the signal-receiving module for each of the channels; and
having a channel-selecting module select one of the channels, which corresponds to the shortest response time, for data transmission according to the response time for each of the channels calculated by the load-judging module, wherein the channel-selecting module further provides a function of determining whether the channel should be switched based on a channel switching reference preset by a user.

2. The dynamic network load balancing method of claim 1, wherein the channel switching reference preset by the user is selected from the group consisting of a threshold value for channel switching preset by the user and a predetermined transmitting data size.

3. The dynamic network load balancing method of claim 2, wherein the threshold value of channel switching preset by the user is a response time of data packets preset by the user.

4. The dynamic network, load balancing method of claim 2, wherein the predetermined transmitting data size is a size of data to be transmitted.

5. The dynamic network load balancing method of claim 4, wherein the size of data to be transmitted is dynamically altered according to a remaining size of data after data transmission has started.

6. The dynamic network load balancing method of claim 1, wherein the wireless communication network is a wireless local area architecture.

7. The dynamic network load balancing method of claim 6, wherein the wireless local area architecture complies with IEEE 802.11 specification.

8. The dynamic network load balancing method of claim 1, wherein the station is a data processing device having a wireless communication function.

9. The dynamic network load balancing method of claim 1, wherein the modules are selected from the group consisting of software programming modules, hardware modules and firmware modules.

10. A dynamic network load balancing system applicable to a wireless communication network, comprising:
a channel-detecting module for detecting channels that provide wireless communications between stations and a plurality of access points;
a signal-sending module for sending a probing data packet to each of the access points in a predetermined period via the channels detected by the channel-detecting module;
a signal-receiving module for receiving a response data packet from each of the access points after the access points have received the probing data packets;
a load-judging module for calculating a response time between sending the probing data packet by the signal-sending module and receiving the response data packet by the signal-receiving module for each of the channels; and
a channel-selecting module for selecting one of the channels, which corresponds to the shortest response time, for data transmission according to the response time for each of the channels calculated by the load-judging module, wherein the channel-selecting module further provides a function of determining whether the channel should be switched based on a channel switching reference preset by a user.

11. The dynamic network load balancing system of claim 10, wherein the channel switching reference preset by the user is selected from the group consisting of a threshold value for channel switching preset by the user and a predetermined transmitting data size.

12. The dynamic network load balancing system of claim 11, wherein the threshold value of channel switching preset, by the user is a response time of data packets preset by the user.

13. The dynamic network load balancing system of claim 11, wherein the predetermined transmitting data size is a size of data to be transmitted.

14. The dynamic network load balancing system of claim 13, wherein the size of data to be transmitted is dynamically altered according to a remaining size of data after data transmission has started.

15. The dynamic network load balancing system of claim 10, wherein the wireless communication network is a wireless local area architecture.

16. The dynamic network load balancing system of claim 15, wherein the wireless local area architecture complies with IEEE 802.11 specification.

17. The dynamic network load balancing system of claim 10, wherein the station is a data processing device having a wireless communication function.

18. The dynamic network load balancing system of claim 10, wherein the modules are selected from the group consisting of software programming modules, hardware modules and firmware modules.
